(19) United States
(12) Patent Application Publication
(10) Pub. No.: US 2008/0053796 A1
(43) Pub. Date: Mar. 6, 2008

(54) VERTICAL ELEVATING BELT CONVEYOR

(75) Inventors: Joseph M. DePaso, River Ridge, LA (US); David C. Weiser, River Ridge, LA (US)

Correspondence Address: LAITRAM, L.L.C.;LEGAL DEPARTMENT, 220 LAITRAM LANE, HARAHAN, LA, 70123, US

(73) Assignee: LAITRAM, L.L.C., Harahan, LA (US)

(21) Appl. No.: 11/466,524

(22) Filed: Aug. 23, 2006

(51) Int. Cl. B65G 15/44

(52) U.S. Cl. 198/801; 198/698; 198/626.1; 198/836.1

(57) ABSTRACT

An elevating belt conveyor and a method for conveying articles up steep inclines. The conveyor has a series of support elements extending outward from the article-conveying surface of a conveyor belt advancing upward along a steep incline. The support elements prevent conveyed articles from sliding down the conveyor belt on the incline. A closely positioned hugger belt facing the article-conveying surface of the conveyor belt advances in the same direction to provide a low-friction retention surface to articles leaning away for the conveyor belt on the incline. In another variation, the support elements may be positioned on the hugger belt rather than on the main conveyor belt, with the main conveyor belt restraining articles against falling from the conveyor on an incline. Alternatively, a vertical array of rollers replaces the hugger belt as a low-friction retaining surface.

### BACKGROUND

The invention relates generally to power-driven conveyors and, more particularly, to belt conveyors advancing on steep inclines to elevate articles, especially high-friction articles.

In a tire manufacturing plant, tires molded in rows of tires presses are deposited on a trench conveyor and transported to an inspection, balance, or trim station. Because trench conveyors are typically positioned below the presses at a relatively low elevation, incline conveyors are used to elevate the tires received from the trench conveyor to the level of the presses or higher for transport to subsequent finishing stations. Belt conveyors, such as modular plastic belt conveyors with high-friction conveying-surface characteristics, work well on shallow inclines. On steeper inclines, however, belts with conveying surfaces textured with inverted cones or other non-skid protrusions work well when new. As the protrusions wear, tires begin to slide down the conveying surface as the belt advances up a steep incline. Rubber-topped belts are not so susceptible to wear, but the slippery mold-release material used to ease ejection of the tires from the presses coats the rubber conveying surface of the belt, which then loses its effectiveness as a high-friction surface. Consequently, incline angles are limited to a maximum of about 25° off horizontal. Such shallow inclines have a large footprint, taking up valuable floor space. Even if tires could be prevented from sliding along the conveying surface on steep inclines, there must be provisions to prevent tires from falling away from the belt. A wall or other static structure in sliding contact with high-friction articles, such as tires, being lifted on the incline can damage the articles and will increase the load, requiring an oversized belt and drive system.

Thus, there is a need for an elevating conveyor capable of transporting articles, especially high-friction articles, up steep inclines.

### SUMMARY

This need and other needs are satisfied by a conveyor embodying features of the invention. One version of the conveyor comprises an endless conveyor belt having an outer article-conveying surface. The conveyor belt advances in a direction of belt travel along a conveying path that includes a steeply inclined portion. The conveying belt also includes support elements that extend outward from the outer article-conveying surface of the conveyor belt at periodically spaced positions. Retention means disposed along the steeply inclined portion proximate the support elements prevent conveyed articles from falling away from the conveyor belt on the steeply inclined portion.

In another version, the conveyor comprises an endless conveyor belt having an outer article-conveying surface. The conveyor belt advances in a direction of belt travel along a conveying path that includes a steeply inclined portion. The conveying belt further includes support elements that extending outward from the outer article-conveying surface of the conveyor belt. An article-restraining surface facing the article-conveying surface of the conveyor belt is positioned outward of the support elements across gaps along the steeply inclined portion of the conveying path. The article-restraining surface engages outwardly leaning conveyed articles moving upward on the steeply inclined portion of the conveying path in low-friction contact. The article-restraining surface may be the outer surface of a belt advancing in the direction of belt travel or the outer surfaces of an array of rollers rotating in the direction of belt travel on contact with outwardly leaning conveyed articles.

According to another aspect of the invention, a method for conveying articles up steep inclines comprises: (a) conveying articles on the conveying surface of an endless conveyor belt along a steep incline in a direction of belt travel; (b) blocking conveyed articles from sliding down the conveying surface of the conveyor belt on the steep incline; and (c) restraining conveyed articles leaning away from the conveying surface with a restraining surface moving in the direction of belt travel to prevent the leaning articles from falling away from the conveying surface of the conveyor belt on the steep incline.

### BRIEF DESCRIPTION OF THE DRAWINGS

These features and aspects of the invention, as well as its advantages, are better understood by reference to the following description, appended claims, and accompanying drawings, in which:

FIG. 1 is a side elevation view of one version of an elevating belt conveyor embodying features of the invention, including a hugger belt;

FIG. 2 is an elevation view of a portion of the conveyor belt of the elevating conveyor of FIG. 1 looking toward the outer article-conveying surface of the conveyor belt;

FIG. 3 is an isometric view of a conveyor belt module with a replaceable support element usable in a conveyor as in FIG. 1;

FIG. 4 is a side elevation view of another version of an elevating belt conveyor, in which support elements are on the opposite belt from that in FIG. 1;

FIG. 5 is a side elevation view of another version of an elevating belt conveyor embodying features of the invention, including a roller array to prevent conveyed articles form falling off the belt;

FIG. 6 is a perspective view of a portion of a roller array usable in the elevating belt conveyor of FIG. 5;

FIG. 7 is an elevation view of a portion of a conveyor belt usable in the elevating conveyor of FIG. 1 looking toward the outer article-conveying surface of the conveyor belt and showing contoured posts used as support elements;

FIG. 8 is an elevation view of a portion of a conveyor belt usable in the elevating conveyor of FIG. 1 looking toward the outer article-conveying surface of the conveyor belt and showing chevron-shaped flights used as support elements; and

FIG. 9 is an elevation view of a portion of a conveyor belt usable in the elevating conveyor of FIG. 1 looking toward the outer article-conveying surface of the conveyor belt and showing stretchable elastomeric bands used as support elements.

### DETAILED DESCRIPTION

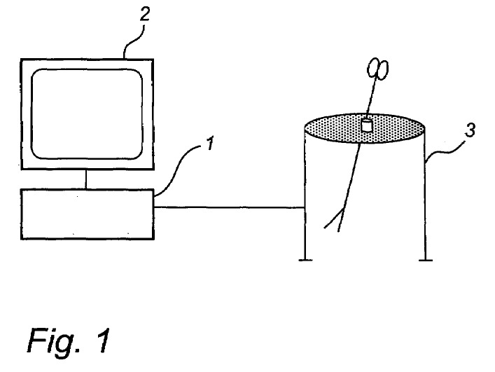

One version of an elevating conveyor embodying features of the invention is shown in FIG. 1. Articles, illustrated as tires 10, are fed by a metering conveyor 12 onto an elevating conveyor 14. The elevating conveyor includes an endless conveyor belt 16 looped around rotating drive elements 18, such as sprockets, drums, or pulleys, which advance the conveyor belt in a direction of belt travel 20 along a conveying path. The endless conveyor belt loop has an outer article-conveying surface 22 and an inner drive surface 23 engaged by the drive elements. On a steeply inclined elevating portion of the conveying path, the articles 10 are conveyed vertically or at a steep angle. The articles 10 are maintained in position and blocked from sliding down the outer surface of the conveyor belt on the steeply inclined portion of the conveying path by support elements 24 that extend outward from the outer surface. The support elements are periodically spaced along the length of the conveyor belt to form individual bins 26 for the articles. (A steep incline for a given conveyor belt is defined as a conveying path that is so steep that typical vibrations, jolts, or surges cause conveyed articles supported on support elements to fall from the conveyor belt advancing along the incline.)

While the support elements serve as slide-prevention means, a hugger belt 28 serves as retention means for preventing articles from falling off the conveyor belt on steep inclines. The hugger belt has a generally flat outer article-retaining surface 30 that faces the outer article-conveying surface 22 of the conveyor belt 16 along the steep incline. The hugger belt, which is positioned across a small gap 31 close to, but out of contact with, the support elements 24, is driven in the direction of belt travel by drive elements 32, preferably at about the same speed as the elevating conveyor belt. Alternatively, the hugger belt could be a passive belt trained around idle sprockets or pulleys and driven in the direction of belt travel by contact with an article leaning outward of the conveyor belt. (To simplify the drawings, the return paths of the hugger belt and other belts are not always shown.) If a conveyed article leans away from the conveyor belt on the steep incline, the article contacts the hugger belt, which limits the lean by restraining the leaning article from further outward movement. Cooperating with the support elements, the hugger belt confines the article to its bin. By advancing at the same speed as the elevating conveyor belt, the hugger belt, whether active and driven by drive elements or passive and driven by frictional contact with outward-leaning articles, engages leaning articles with no relative motion and, consequently, no sliding friction. Once the articles are conveyed up the incline, they are transferred to an outfeed conveyor 34 for transport to downstream finishing stations.

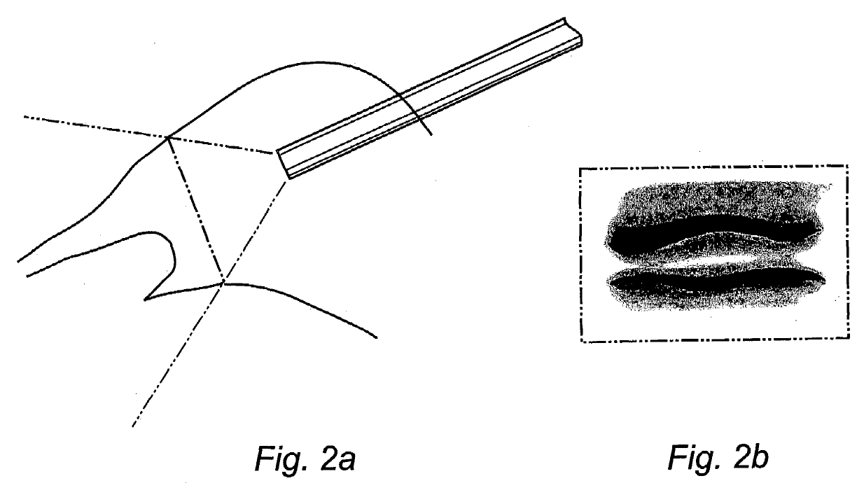

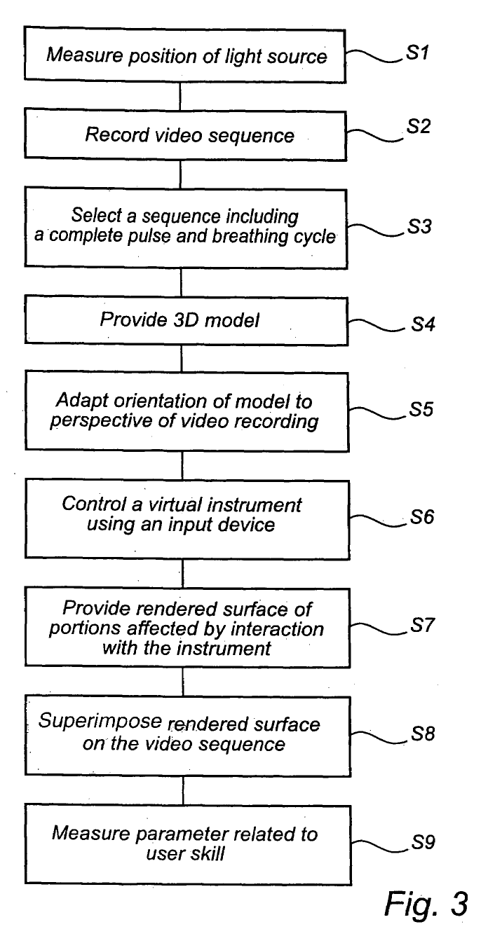

Further details of exemplary slide-preventing support elements are shown in FIGS. 2 and 3. Each bin 26 is defined by a pair of support elements 36, 37. The elements shown are rectangular blocks extending outward from the article-conveying surface 22 of the conveyor belt 16. The blocks may be integrally formed with the belts, but are preferably attached to a threaded insert in the belt by a bolt 38 or the like through a bore 40 formed in the block. The conveyor belt is preferably a modular plastic conveyor belt constructed of a series of individual belt modules 42 made of a thermoplastic polymer, such as polypropylene, polyethylene, acetal, or a composite material, in an injection-molding process. A threaded metallic insert can be inserted into the module during or after molding to serve as an attachment point for a support element. The details of one such insert and its use are described in U.S. Pat. No. 6,926,134, “Plastic Conveyor Belt Module with Embedded Fasteners,” which is incorporated into this description by reference. Of course, other methods can be used to fasten the support elements to the conveyor belt. The modules are connected together and with other similar modules without support elements side by side and end to end by hinge rods 43 through hinge eyes 45 to form an endless modular conveyor belt.

The two blocks shown in FIG. 2 are spaced apart laterally across the width of the conveyor belt. The blocks have article-supporting faces 44, 44′ defining planes 46, 46′ oblique to the direction of belt travel 20 and intersecting below the blocks on the steep incline. The two blocks provide two points of support for round articles, such as tires, and the space between them allows debris or fluids to drop from the compartments.

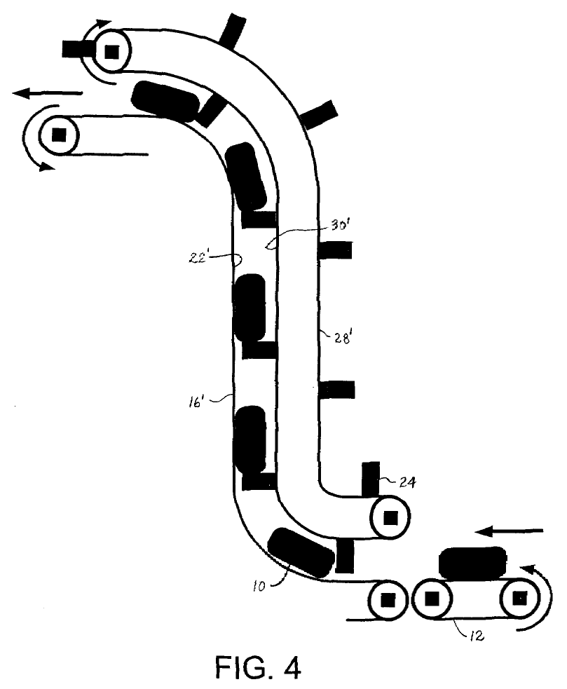

A variation in the elevating conveyor of FIG. 1 is shown in FIG. 4. In this version, a main belt 16′ that receives articles 10 from the metering conveyor 12 does not have support elements. In this way, the metering conveyor can be positioned closer to the main belt because clearance for the support elements between the main belt and the metering conveyor is not needed. This makes for a simpler and more space-efficient transfer of articles onto and off the ends of the main belt. Support elements 24 are instead attached to a hugger belt 28′ to lift conveyed articles on the incline. The main belt, which runs in parallel with the hugger belt on the incline, prevents articles leaning outward of the outer surface 30′ of the hugger belt from falling off the conveyor. Thus, in this variation, the outer surface 22′ of the main belt 16′ serves as retention means for articles being lifted and prevented from sliding by the support elements 24 on the hugger belt 28′, which acts as the conveyor belt on the inclined portion of the conveying path.

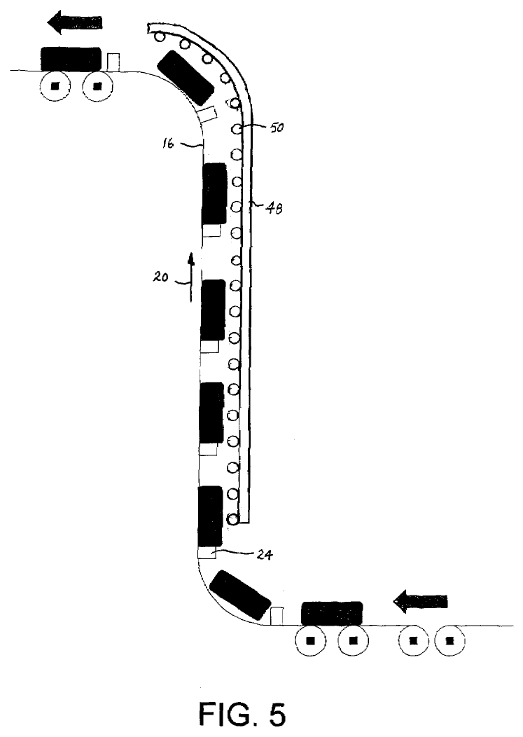

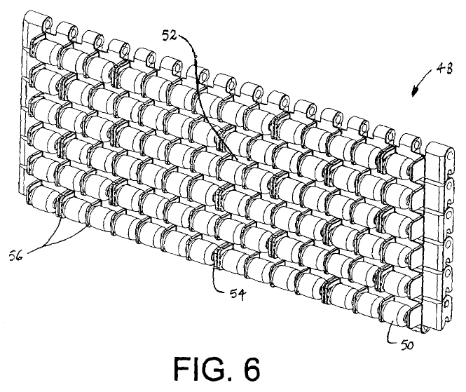

The hugger belt 28 used as retention means in FIGS. 1 and 2 is replaced with an array 48 of rollers 50 in FIGS. 5 and 6. Like the hugger belt, the array of rollers is positioned close to the support elements 24, but without contact. An article that leans away from the conveyor belt on the steep incline is restrained by the article-retaining outer surfaces of the rollers, which also rotate in the direction of belt travel 20 on contacting the articles being elevated. The rollers may be cylindrical and mounted for rotation on horizontal axles or roller freely rotatable balls, for example. As shown in FIG. 6, a roller array made of a portion of a portion of a modular plastic roller-top conveyor belt 52 stationarily supported vertically is used to form the roller array. The rollers 50 rotate on horizontal axles 54 supported on stanchions 56 spaced apart across the width of the mat. The rollers provide a low-friction, rolling restraining surface that is especially useful with high-friction articles, such as tires.

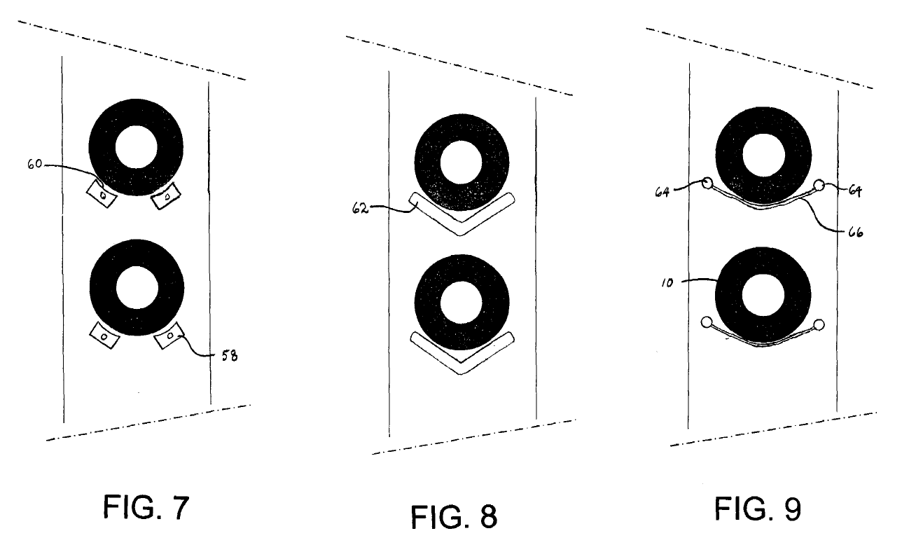

Other versions of support elements are shown in FIGS. 7-9. The support elements in FIG. 7 are posts 58 that have article-supporting faces 60 contoured to complement the shape of and to mate with a conveyed article. The support elements in FIG. 8 are chevron-shaped flights 62 serving as pockets for conveyed articles. Each flight may be a single piece or segmented. In FIG. 9, each support element constitutes a pairs of pins 64 between which an elastomeric band 66 is strung. The weight of the conveyed article pushing on the elastomeric band stretches the band to conform to the outer surface of the conveyed article 10. These are just a few more examples of supporting elements that are usable in the conveyors of FIGS. 1, 4 and 5. Other support elements, such as buckets, transverse flights, or arrays of pins, could alternatively be used.

Although the invention has been described in detail with respect to a few preferred versions, other versions and variations are possible. For example, the conveyor belt described as a modular plastic conveyor belt could be a flat belt or a flat-top chain. As another example, a vertically arranged gravity roller or skate-wheel conveyor could be used instead of the roller-top belt mat of FIG. 5 to prevent outwardly leaning articles from falling off the conveyor belt. So, as these few examples suggest, the claims are not meant to be limited to the details of the preferred versions.

What is claimed is:

1. A conveyor for conveying articles up steep inclines, the conveyor comprising:
an endless conveyor belt having an outer article-conveying surface and advancing in a direction of belt travel along a conveying path including a steeply inclined portion, the conveyor belt further including support elements extending outward from the outer article-conveying surface of the conveyor belt at periodically spaced positions; and
retention means disposed along the steeply inclined portion proximate the support elements to prevent conveyed articles from falling away from the conveyor belt on the steeply inclined portion.

2. A conveyor as in claim 1 wherein the support elements include a first element and a second element spaced apart laterally across the width of the conveyor belt at each periodically spaced position.

3. A conveyor as in claim 2 wherein the first element has an article-supporting face defining a first plane oblique to the direction of belt travel and the second has an article-supporting face defining a second plane oblique to the direction of belt travel, wherein the first and second planes intersect below the first and second elements along the steeply inclined portion of the conveying path.

4. A conveyor as in claim 1 wherein the support elements are contoured in shape to mate with a conveyed article.

5. A conveyor as in claim 1 wherein the support elements are made of an elastomeric material that conforms to the shape of a conveyed article on the steeply inclined portion of the conveying path.

6. A conveyor as in claim 1 wherein the retention means cooperates with the support elements without contact in conveying articles without sliding and falling along the steeply inclined portion of the conveying path.

7. A conveyor as in claim 1 wherein the retention means comprises a belt facing the outer article-conveying surface of the conveyor belt and advancing in the direction of belt travel along the steeply inclined portion of the conveying path at a spacing from the outer article-conveying surface close enough to prevent conveyed articles from falling away from the conveyor belt, wherein the belt advances at the same speed as the conveyor belt for low-friction contact with conveyed articles.

8. A conveyor as in claim 1 wherein the retention means comprises an array of rollers closely spaced apart from the support elements along the steeply inclined portion of the conveying path and arranged to be rotatable in the direction of belt travel to provide low-friction contact with conveyed articles that separate from the outer article-conveying surface of the conveyor belt.

9. A conveyor as in claim 1 wherein the steeply inclined portion of the conveying path is substantially vertical.

10. A conveyor for conveying articles up steep inclines, the conveyor comprising:
an endless conveyor belt having an outer article-conveying surface and advancing in a direction of belt travel along a conveying path including a steeply inclined portion, the conveying belt further including support elements extending outward from the outer article-conveying surface of the conveyor belt;
an article-restraining surface facing the article-conveying surface of the conveyor belt positioned outward of the support elements across gaps along the steeply inclined portion of the conveying path and engaging outwardly leaning conveyed articles moving upward on the steeply inclined portion of the conveying path in low-friction contact.

11. A conveyor as in claim 10 comprising a belt advancing in the direction of belt travel and having an outer surface forming the article-restraining surface.

12. A conveyor as in claim 10 comprising an array of rollers having outer surfaces forming the article-restraining surface facing the article-conveying surface and positioned outward of the support elements across gaps along the steeply inclined portion of the conveying path, wherein the rollers are arranged to rotate in the direction of belt travel on contact with outwardly leaning conveyed articles.

13. A method for conveying articles up steep inclines, the method comprising:
conveying articles on the conveying surface of an endless conveyor belt along a steep incline in a direction of belt travel;
blocking conveyed articles from sliding down the conveying surface of the conveyor belt on the steep incline; and
restraining conveyed articles leaning away from the conveying surface with a restraining surface moving in the direction of belt travel to prevent the leaning articles from falling away from the conveying surface of the conveyor belt on the steep incline.
